(19) United States
(12) Patent Application Publication
(10) Pub. No.: US 2014/0330604 A1
(43) Pub. Date: Nov. 6, 2014

(54) OPERATOR ASSISTANCE SYSTEM AND METHOD

(71) Applicant: General Electric Company, Schenectady, NY (US)

(72) Inventors: PAUL CONNOLLY, ERIE, PA (US); AARON MITTI, ATLANTA, GA (US); MARTIN PAGET, SAINT JOHNS, FL (US)

(73) Assignee: General Electric Company, Schenectady, NY (US)

(21) Appl. No.: 14/264,290

(22) Filed: Apr. 29, 2014

Related U.S. Application Data
(63) Continuation-in-part of application No. 14/255,005, filed on Apr. 17, 2014.
Application No. 14/255,005 is a continuation-in-part of application No. 14/186,018, filed on Feb. 21, 2014.
Application No. 14/186,018 is a continuation-in-part of application No. 14/242,941, filed on Apr. 2, 2014.
Application No. 14/242,941 is a continuation-in-part of application No. 13/886,396, filed on May 3, 2013.
(60) Provisional application No. 61/874,132, filed on Sep. 5, 2013.
(60) Provisional application No. 61/874,178, filed on Sep. 5, 2013.

(51) Int. Cl. G06Q 10/06

(52) U.S. Cl. CPC G06Q 10/06316; G06Q 10/063114
USPC 705/7.15

(57) ABSTRACT

A method for assisting operators performing tasks on assets includes remotely monitoring locations of mobile electronic devices associated with performance of tasks on one or more assets by the operators, remotely monitoring progress of completion of the tasks, and, based on at least one of the locations that are monitored or the progress of completion of the tasks, at least one of: altering an order in which the tasks are to be completed to reduce at least one of a completion time or completion cost of the tasks, communicatively coupling the mobile electronic devices with one or more expert personnel to assist the operators in completing the tasks, or generating a visual presentation on at least one of the mobile electronic devices that illustrates at least one of progress or problems with completion of the tasks.

### CROSS-REFERENCE TO RELATED APPLICATIONS

This application claims priority to U.S. Provisional Application No. 61/874,132, which was filed on 5 Sep. 2013, and is titled “Expert Collaboration System And Method” (the “'132 Application”), and claims priority to U.S. Provisional Application No. 61/874,178, which was filed on 5 Sep. 2013, and is titled “Services Support System And Method” (the “'178 Application”). This application also is a continuation-in-part of U.S. patent application Ser. No. 14/255,005, which was filed on 17 Apr. 2014 and is titled “System And Method For Improving Efficiency Of A Workforce” (the “'005 Application”), and is a continuation-in-part of U.S. patent application Ser. No. 14/186,018, which was filed on 21 Feb. 2014 and is titled “Vehicle Emissions Test Systems And Methods” (the “'018 Application”), and is a continuation-in-part of U.S. patent application Ser. No. 14/242,941, which was filed on 2 Apr. 2014 and is titled “System And Method For Monitoring And Scheduling A Workforce” (the “'941 Application”). The '941 application is a continuation-in-part of U.S. patent application Ser. No. 13/886,396, which was filed on 3 May 2013, and is titled “System And Method For Scheduling” (the “'396 Application”). The entire disclosures of the '132 Application, the '178 Application, the '005 Application, the '018 Application, the '941 Application, and the '396 Application are incorporated by reference.

### FIELD

Embodiments of the subject matter described herein relate to remotely assisting operators through performing tasks on assets.

### BACKGROUND

Some known systems provide guidance to users during the examination and/or repair of equipment, such as vehicle systems. These systems can provide relatively generic instructional guides that direct the user how to repair or replace parts of the equipment. These guides may be limited to text-based instructions that do not visually instruct the user how to perform the examination and/or repair. Additionally, some of these guides may include directives to the user that result in the user taking relatively unsafe actions. Moreover, these guides typically are provided without regard to how long the repair and/or examination will take, the cost of the repair and/or examination, and the availability of necessary tools or equipment for conducting the repair and/or examination.

### BRIEF DESCRIPTION

In one embodiment, a method (e.g., for assisting operators performing tasks on assets) includes remotely monitoring locations of mobile electronic devices associated with performance of tasks on one or more assets by operators, remotely monitoring progress of completion of the tasks, and, based on at least one of the locations that are monitored or the progress of completion of the tasks, at least one of: altering an order in which the tasks are to be completed to reduce at least one of a completion time or completion cost of the tasks, communicatively coupling the mobile electronic devices with one or more expert personnel to assist the operators in completing the tasks, or generating a visual presentation on at least one of the mobile electronic devices that illustrates at least one of progress or problems with completion of the tasks.

In another embodiment, another method (e.g., for assisting operators performing tasks on assets) includes communicating instruction signals from one or more networked computer devices to one or more mobile electronic devices. The instruction signals direct the one or more mobile electronic devices to generate visual presentations to guide one or more operators through tasks to be completed on one or more assets. The method also can include receiving, from the one or more mobile electronic devices, responsive signals that notify the one or more networked computer devices of one or more of: locations of the one or more mobile electronic devices during performance of the tasks by the one or more operators, locations of at least one of tools or equipment used to perform the tasks, an indication of at least one of an unsafe condition or an unsafe task directed by the visual presentations, requests for remote assistance in completing the tasks by one or more expert personnel remotely located from the locations of the one or more mobile electronic devices, or progress of completion of the tasks. The method also can include, responsive to receiving the responsive signals, at least one of: altering an order in which the tasks are completed in order to at least one of eliminate the unsafe condition or unsafe task or reduce at least one of a completion time or completion cost of the tasks, communicatively coupling at least one of the operators with at least one of the expert personnel via the one or more mobile electronic devices, or visually presenting a summary of the progress of the completion of the tasks on at least one of the mobile electronic devices.

In another embodiment, a system (e.g., an operator assistance system) includes one or more networked computer devices including one or more computer processors. The one or more networked computer devices are configured to remotely monitor locations of mobile electronic devices associated with performance of tasks on one or more assets by operators. The one or more networked computer devices also are configured to receive signals from the mobile electronic devices and, based on the signals that are received, remotely monitor progress of completion of the tasks on the one or more assets and, based on at least one of the locations that are monitored or the progress of completion of the tasks, at least one of: alter an order in which the tasks are to be completed to reduce at least one of a completion time or completion cost of the tasks, communicatively couple the mobile electronic devices with one or more expert personnel to assist the operators in completing the tasks, or generate a visual presentation on at least one of the mobile electronic devices that illustrates at least one of progress or problems with completion of the tasks.

### BRIEF DESCRIPTION OF THE DRAWINGS

The subject matter described herein will be better understood from reading the following description of non-limiting embodiments, with reference to the attached drawings, wherein below:

FIG. 1 is a schematic diagram of an operator assistance system according to an embodiment of the invention;

FIG. 2 is a schematic illustration of a mobile electronic device shown in FIG. 1 according an embodiment;

FIG. 3 illustrates a display screen that is displayed on an output device shown in FIG. 2 of the mobile electronic device shown in FIG. 2 according an embodiment;

FIG. 4 illustrates an additional display screen that may be shown on the mobile electronic device shown in FIG. 1 during a health check on one or more assets according to an embodiment;

FIG. 5 illustrates an additional display screen that may be shown on the mobile electronic device shown in FIG. 1 during a health check on one or more assets according to an embodiment;

FIG. 6 illustrates another example of a status presentation that can be visually presented on the mobile electronic device shown in FIG. 1 of an operator according to an embodiment; and

FIG. 7 illustrates a flowchart of a method for assisting operators performing tasks on assets according to an embodiment.

### DETAILED DESCRIPTION

One or more aspects of the inventive subject matter described herein relate to systems and methods for remotely monitoring, tracking, and or assisting operational personnel and/or equipment in performing tasks to complete projects on various assets. By way of example, the assets can include mobile assets such as vehicles (e.g., locomotives, automobiles, mining vehicles, marine vessels, airplanes, or the like), stationary assets or assets that are not capable of self-propulsion, equipment that is used to service, repair, inspect, or otherwise maintain the assets (e.g., lifts, inspection systems, or the like), materials used by the assets during operations of the assets (e.g., fuel, replacement parts, batteries, or the like), or other types of systems. A set of tasks may need to be performed on an asset to repair the asset, inspect the asset, maintain the asset, or otherwise prepare the asset for performance of one or more missions or operations. For example, prior to a rail vehicle consist departing a rail yard, one or more sets of tasks may need to be performed on the locomotives, rail cars, couplers, or the like, before the rail vehicle consist can leave the rail yard. These tasks can include inspecting brake systems, checking computer systems to make sure the correct information is loaded in the systems for use in controlling the consist during the upcoming trip, inspecting wheels of the consist for uneven wear, or the like.

One or more embodiments of the systems and methods described herein can assist in remotely tracking, locating, and checking on the status of personnel, completion of the tasks on an asset, the assets themselves, equipment, tools, or the like. Optionally, the personnel can remotely obtain additional guidance or advice from documents that are remotely stored from the assets, expert personnel located remote from the assets, or the like. The personnel may be remotely guided through completion of the tasks on an asset, and may request additional guidance from a remote resource and/or notify others of problems or safety hazards associated with the tasks being completed on an asset.

At least one technical effect provided by the inventive subject matter described herein includes remotely guiding a user through the examination, repair, and/or replacement of a component subsystem of equipment using instructions presented on a mobile device used by the user. Experts may remotely provide guidance information to the user's mobile device, and can collaborate with the user during the examination, repair, and/or replacement operations, such as by sharing images and/or videos, annotating images, providing documents, changing the information that is provided to the user during the examination, repair, and/or replacement operations, and the like. Similarly, the mobile device user may send data, image, audio or video information from the mobile device to the one or more persons for their evaluation. That transmitted information may be used by the expert to select which subset of guidance information to update to the mobile device.

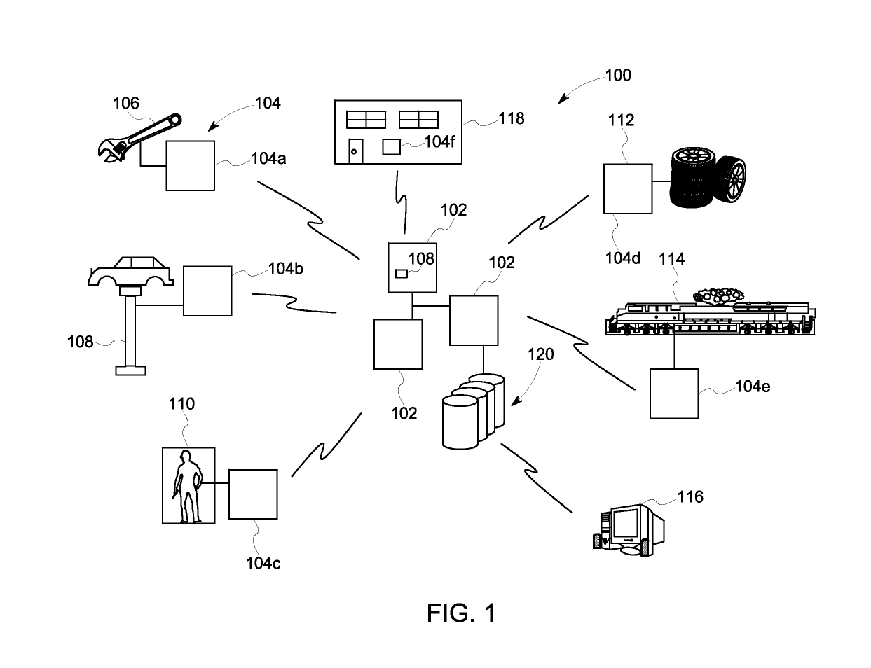

FIG. 1 is a schematic diagram of an operator assistance system 100 according to one example of the inventive subject matter described herein. The system 100 includes one or more networked computer devices 102 (also referred to as networked computers) that are connected with each other, such as by wired and/or wireless connections, so that the networked computer devices 102 are able to communicate with each other. The networked computer devices 102 include one or more hardwired or hardware circuits or circuitry that includes and/or is connected with one or more computer microprocessors 108.

The networked computer devices 102 may be connected by wired and or wireless communication connections, wires, cables, buses, wireless networks, or the like. The networked computer devices 102 may be located in the same building or facility, or in different buildings and facilities. The networked computer devices 102 include and/or are connected with one or more memory devices 120, such as computer hard drives, flash drives, databases, or the like. The memory devices 120 can store data representative of information that is used to assist and or guide the operators through performance of tasks on various assets.

The networked computer devices 102 communicate with several remotely located mobile electronic devices 104 (e.g., devices 104a-f). The networked computer devices 102 can communicate (e.g., transmit and/or broadcast) instruction signals to the mobile electronic devices 104 and/or can receive responsive signals or request signals from the mobile electronic devices 104. The instruction signals direct the mobile electronic devices 104 to visually present various displays to the operators, as described herein, and/or to present various data or information to the operators. The responsive or request signals from the mobile electronic devices 104 can be sent to communicate data parameters (e.g., operational settings, sensor readings, locations, or the like) to the networked computer devices 102, to communicate requests for assistance or other information, or the like.

The mobile electronic devices 104 include computing devices, such as handheld tablet computers, mobile phones, location beacons, stationary computers (e.g., desktop), mobile computers (e.g., laptop computers), onboard computers of the assets (e.g., navigation systems, software systems that control operations of the assets), wearable computers (e.g., smart watches, head mounted cameras and/or displays, etc.), or the like. The mobile electronic devices 104 can be moved between locations, such as by being connected to or carried by other devices, systems, persons, or the like, that move between locations. The devices 102, 104 can communicate with each other via one or more wired and/or wireless connections, which can include public and/or private networks.

The mobile electronic devices 104 can be connected with, disposed within, carried by, and/or otherwise associated with a variety of assets and/or operational personnel. For example, the mobile electronic device 104a can be connected with one or more tools 106 that are used by operational personnel to perform tasks on assets. The tool 106 can represent a mechanical device that is handled by a person during performance of the tasks, a software system that is used by the person during performance of the tasks, or the like. The mobile electronic device 104b can be connected with equipment 108 that is used to perform tasks on the assets, such as a camera, inspection device, light, sensor, pneumatic and/or electronic lift, or the like. The equipment 108 can be referred to as a stationary asset, as the equipment 108 may not be capable of self-propulsion. The equipment 108 can be referred to as a stationary asset even though the equipment 108 may be moved between different locations.

The mobile electronic device 104c can be connected or otherwise carried by operational personnel 110, such as a human operator or personnel that manually performs tasks on assets and/or monitors performance of the tasks by other operator or personnel. Such a mobile electronic device 104c can include a mobile phone, a tablet computer, or the like. The mobile electronic device 104d can be connected with or otherwise disposed near consumable assets 112, such as material resources that are used, consumed, or prepared for consumption or use in connection with performance of the tasks on the assets. For example, the assets 112 can represent replacement parts, fuel, batteries, or the like, that are used or consumed in preparing the assets for operations. The mobile electronic device 104d can be connected to the assets 112, such as a beacon, radio frequency identification (RFID) tag, sensor, or the like, so that the location and/or status of an asset 112 can be remotely monitored. Optionally, the mobile electronic device 104d can represent and/or be connected with a camera that obtains image data (e.g., still images and/or video) to monitor the assets 112. The mobile electronic device 104e can be connected with or otherwise disposed onboard a mobile asset 114, such as a vehicle that is capable of self-propulsion. Optionally, the mobile asset 114 may not be capable of self-propulsion, but may be moved during normal operation of the asset 114 (e.g., a rail car that carries cargo). The mobile electronic device 104f can be connected or otherwise disposed in a facility 118, such as a building where tasks may be performed on the assets.

The networked computer devices 102 and one or more of the mobile electronic computer devices 104 can be communicatively coupled with one or more expert computer devices 116. The mobile electronic devices 104 can be directly connected to each other and/or the expert computer device 116, or may be connected via the networked computer devices 102. The expert computer device 116 can be located remotely from the networked computer devices 102 and/or the mobile electronic devices 104. The expert computer device 116 can be a computer, tablet computer, or the like that is used by one or more persons having greater expertise and/or experience in performing one or more tasks on the assets than the operators 110. The expert computer device 116 can communicate with the mobile electronic devices 104 (e.g., the device 104c) in order to direct and/or assist the operators 110 in performing tasks on the assets 108, 112, 114.

In one aspect of the inventive subject matter described herein, the system 100 may be used to remotely monitor locations of the mobile electronic devices 104 during performance of the tasks on the assets 108, 112, 114. The tasks that are to be performed on the assets 108, 112, 114 can include an ordered series of tasks that are to be completed to prepare the assets 108, 112, 114 for one or more missions, such as a vehicle traveling to a destination location. For example, tracking devices such as global positioning system (GPS) receivers, transmitting beacons, RFID tags, and the like, can be attached to tools, lifts, or other equipment or tools needed to repair, examine, and or inspect the assets needing to be worked on. The progress of the completion of the tasks can be remotely tracked by the networked computer devices 102 and presented to the mobile electronic devices 104. For example, the rate or percentage of completion of several tasks that are to be performed on the assets 108, 112, 114 can be remotely monitored, and then shown or otherwise reported to management personnel so that management personnel is updated with the progress of different tasks being performed.

The system 100 also can be used to change an order in which the tasks are to be completed on the assets 108, 112, 114 based on monitoring how the tasks are currently performed on the assets 108, 112, 114. Changing this order can reduce the time required to complete the tasks and/or the costs to complete the tasks. For example, by changing the order in which tasks are performed on a vehicle prior to departure, a series of tasks may be completed faster than a previous order of the tasks. The mobile electronic devices 104 can be used to communicate with remotely located expert personnel. The expert personnel may have greater expertise with one or more tasks that need to be completed on the assets 108, 112, 114. The operators may remotely contact these experts and obtain assistance, whether it is a video feed from the expert, an audio feed from the expert, the expert providing documents to assist the operators, or the like. This assistance can be provided by the expert personnel on to the mobile electronic devices that are carried by the operators while completing the tasks on the assets.

Personnel 110 can be assisted with performing the tasks by generating a visual presentation on the mobile electronic device 104c that illustrates the progress or problems with the completion of the tasks that are to be performed on the assets. For example, in addition or as an alternate to showing the progress of the tasks being completed on an asset this visual presentation can also indicate or represent any hold ups or other issues that are delaying completion of tasks on an asset. The mobile electronic devices 104 can provide a mobile platform to assist the personnel 110 in working on various assets, such as vehicles and or other equipment. These mobile electronic devices 104 provide digital tools and resources on a mobile platform to facilitate problem solving, collaboration with other personnel 110 and/or experts, and/or the delivery of informative content to the personnel 110 when and where the personnel 110 need the informative content.

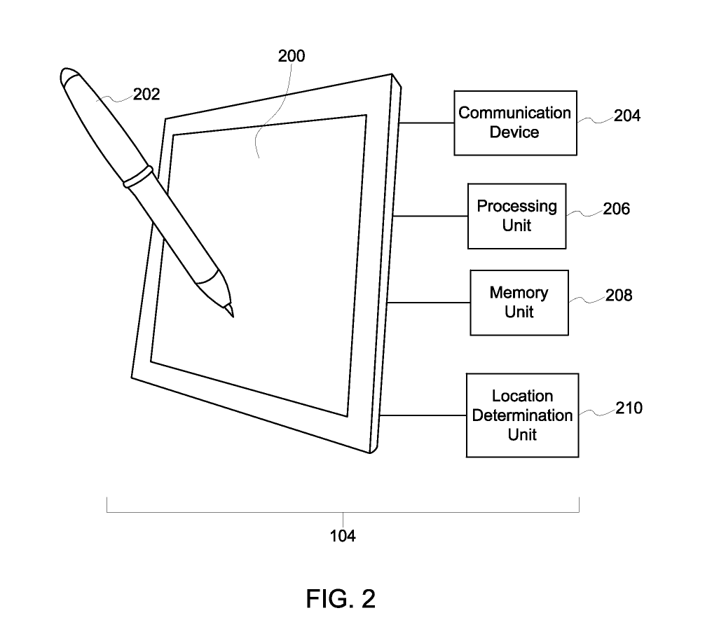

FIG. 2 is a schematic illustration of the mobile electronic device 104 shown in FIG. 1 according to one example of the inventive subject matter described herein. The mobile electronic device 104 includes an output unit 200, such as a display screen, touchscreen, or the like. Optionally, the output unit 200 can include a speaker to generate sounds. The mobile electronic device 104 includes an input unit 202 to receive input from an operator 110 (shown in FIG. 1), such as a stylus, keyboard, microphone, or the like. Optionally, the input unit 202 can be a touchscreen such that both the input and output units 202, 200 use the same screen to both receive input from and provide output to an operator 110.

The mobile electronic device 104 can include additional components that are illustrated as being outside of the output unit 200 of the mobile electronic device 104 in FIG. 2. One or more of these components can be disposed within the same housing that also includes the output unit 200. For example, the mobile electronic device 104 can include a communication device 204 that communicates data with one or more other devices, such as other mobile electronic devices 104, the networked computer devices 102 (shown in FIG. 1), the expert computer device 116 (shown in FIG. 1), or the like. The communication device 204 can represent one or more antenna and wireless transceiving circuitry that can wirelessly communicate (e.g., transmit, broadcast, and/or receive) wireless data signals. Optionally, the communication device 204 can include or represent a connector that can couple with one or more wired connections to communicate the data signals over one or more wires, cables, buses, or the like. A processing unit 206 can include one or more computer processors, such as one or more microprocessors that perform functions of the mobile electronic device 104 based on instructions, such as software. A memory unit 208 includes one or more memory devices, such as a computer hard drive, a flash drive, an optical drive, or the like. A location determination unit 210 includes hardware circuits or circuitry that includes and/or is connected with one or more processors, such as the processing unit 206. The location determination unit 210 generates data representative of the location of the mobile electronic device 104. For example, the location determination unit 210 can include a GPS receiver, an RFID tag or transponder, a wireless antenna, or the like, that generates data representative of where the mobile electronic device 104 is located. In one aspect, the location determination unit 210 can include a beacon that communicates (e.g., transmits or broadcasts) a signal representative of the location of the mobile electronic device 104. This signal may be received by one or more antennas of other devices to determine the location of the mobile electronic device 104.

Optionally, the mobile electronic device 104 may include fewer, additional, or different components than what is shown in FIG. 2. For example, the mobile electronic device 104a may include the location determination unit 210, but not one or more of the communication device 204, the processing unit 206, the output device 200, and/or the input device 202, as the mobile electronic device 104a may be used only to report the location of the tool 106 (shown in FIG. 1).

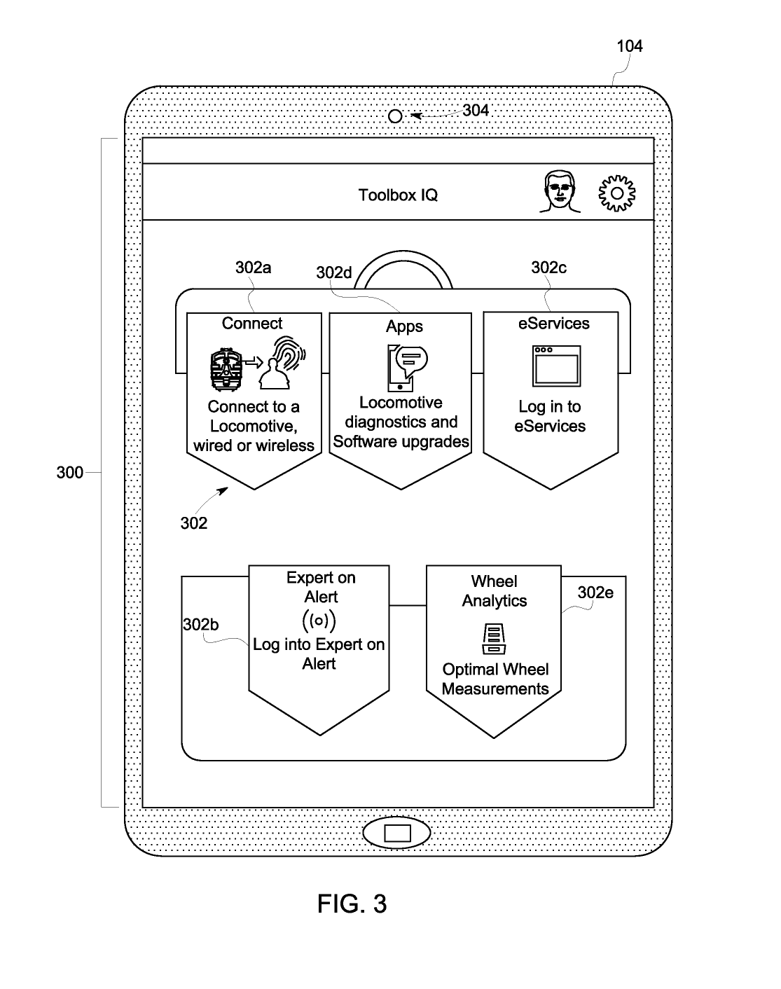

FIG. 3 illustrates a screenshot 300 that is displayed on the output device 200 (shown in FIG. 2) of the mobile electronic device 104 (shown in FIG. 2) according to one example of the inventive subject matter described herein. The processing unit 206 (shown in FIG. 2) can direct the output device 200 to present the screenshot 300 to the operator 110 on the mobile electronic device 104c that is carried by the operator 110.

The screenshot 300 provides several options for the operator 110 to select an application to operate on the mobile electronic device 104c. These applications can be represented by icons 302 (e.g., icons 302a-e), or other graphical items. A connect icon 302a can be selected by the operator 110 in order to remotely connect with one or more assets. For example, by selecting the connect icon 302a, the mobile electronic device 104c can request and/or obtain data from one or more assets, sensors that measure aspects of the assets, or the like. The operator may be able to wirelessly check on one or more operational settings (brake settings, throttle settings, test results, or the like) of the assets to determine the current operational status or state of an asset that is not near the operator. The operator can select the connect icon 302a to check on the current status of an asset that the operator may be waiting on or that the operator needs before the operator can complete a task on the same or other asset. For example, the operator 110 can use the connect icon 302a to check on the status of repairs to an asset that the operator 110 is waiting on to prepare for departure from a facility. The operator 110 can use the connect icon 302a to check on the availability of replacement parts for an asset that the operator 110 is repairing. The operator 110 can use the connect icon 302a to check on the location and/or availability of a tool 106 (shown in FIG. 1) and/or equipment 108 (shown in FIG. 1) that the operator 110 needs to complete a task.

Selection of a services icon 302c can allow an operator to remotely order needed parts, materials, additional workforce personnel to assist with completion of a task, or the like. An apps icon can provide additional software applications stored locally on the mobile electronic device or available remotely to the electronic mobile device to assist in or guide the operator in performing one or more tasks. As one example of such an application, a wheel analytics icon is shown on the exemplary display screen (200) of FIG. 2. As described below, the wheel analytics application can visual guide the operator through examination of a wheel set of one or more vehicles, provide recommendations for how to change the shape and or dimensions of one or more wheels, assist the operator in finding a replacement wheel for a vehicle or the like.

An applications icon 302d can be selected by the operator of the mobile electronic device 104 in order to provide one or more additional software applications or functions of the system 100, as described herein. One example of such a software application or function of the system 100 is a wheel analytics application, which also can be opened by selecting the wheel analytics icon 302e. As described below, this application can assist the operator 110 in measuring wheel dimensions of an asset, determining how to modify the wheel dimensions, determining whether to replace the wheel, and/or identifying a location of a replacement wheel from an inventory of replacement wheels or an approaching vehicle. While FIG. 3 illustrates some icons 302 that may be selected by the operator 110, optionally, a different number, type, and/or arrangement of icons 302 may be used.

An assistance icon 302b can be selected by the operator in order to communicate with expert personnel and/or other operators 110 via the mobile electronic device 104 during performance of tasks on an asset. For example, an operator 110 that is working on a brake system of a locomotive can select the assistance icon 302b in order for the mobile electronic device 104 to be communicatively coupled with the expert computing device 116 and/or another mobile electronic device 104. The devices 104, 116 can be connected so that the operator 110 with the mobile electronic device 104c can ask questions of and/or receive information from one or more other expert personnel or other personnel 110 via the mobile electronic device 104c. This information can include, for example, a question and answer session between the operators 110 and/or expert personnel, or the expert personnel sending images, documents, “to do” lists, check lists, and the like, to the mobile electronic device 104c.

For example, as described in the '132 Application, the operator may select the icon 302b to obtain guidance from one or more of the remotely located experts. Selecting this icon 302b causes the device 104 to communicate a signal that requests an expert communicate with the device 104. The expert may communicate with the operator via the device 104 to assist in identifying a problem or fault with an asset, to guide the operator through repair, maintenance, inspection, or the like, of the asset, or otherwise help the operator. As one example, the expert can provide a work scope to the operator that the operator follows in performing tasks on the asset. The mobile electronic device 104 can present images, videos, or the like, of the work scope to guide the operator through performance of the tasks, as described in the '132 Application. Optionally, the mobile electronic device 104 can receive operator input such as images, user-drawn indicia or markings, or the like, from the operator, and send this input to the expert for analysis, also as described in the '132 Application.

Another application that may be implemented by the mobile electronic device 104 provides for the mobile electronic device 104 to monitor and report on how tasks are being performed by one or more other operators (e.g., a single or multiple human workforce), to examine how these steps are performed to determine if there is a more efficient way in which to perform the steps, and to visually present the more efficient way (e.g., sequence) to perform the steps to the one or more other operators, as described in the '005 Application. The visual presentation of the more efficient way to perform the tasks can be presented to the other operators on mobile electronic devices 104 of those operators, so that these operators can view the more efficient sequence in which to perform the tasks.

The monitoring of how the tasks are performed can involve spatially tracking movements of one or more operators as the operators move about an object being worked on (e.g., preparing a locomotive for departure, repair or maintenance on an automobile, or the like), tracking when various tasks are initiated and/or completed, determining the order in which the tasks are performed, and the like, as described in the '005 Application. The current order in which the tasks are performed can be examined by determining if another order of the tasks results in the mission being completed more efficiently. For example, systems and methods described herein may determine if the current order of the tasks results in redundant movements of the operator (e.g., the operator backtracks over the same locations more than once in completing the tasks), if the placement of tools used by the operator in the current order of tasks can be changed to reduce the time needed to complete the mission and/or to reduce redundant movements of the operator, or the like.

Some of the tasks may be subject to restrictions on when the tasks can be performed relative to each other. For example, in a mission that requires performance of a first task, a second task, a third task, and so on, the third task may be unable to be completed until the first task has been successfully completed. One or more aspects of the systems and methods described herein may examine the current order of the tasks, the movements of the operator, the times at which the tasks are initiated and/or completed, locations of tools needed to complete the tasks, restrictions on the order in which the tasks can be completed, and the like, and determine one or more different orders in which the tasks can be completed to successfully perform the mission.

The one or more different orders of the tasks may be referred to as a recommended or efficient order of the tasks. Performance of the tasks in the recommended or efficient order on another vehicle or other object can result in the mission being completed more efficiently. For example, during preparation of another locomotive for departure from a rail yard, performance of the tasks for the mission of preparing the locomotive for departure in the recommended order can result in this locomotive being prepared for departure in less time than a previous locomotive (in which the tasks were performed in another order). The mobile electronic device 104 and/or one or more of the networked computer devices 102 can monitor the movements of the operators, the locations of tool and equipment assets, and/or the order in which the tasks are completed, and determine the different order of the tasks, different locations of the tool and equipment assets, and/or different movements of the operators. The updated order, locations, and/or movements can then be communicated to mobile electronic devices 104 of the operators in order to guide the operators through the tasks, as described in the '005 Application.

Another software application or functionality that may be provided by the mobile electronic device 104 can include various aspects and functions of the subject matter described in the '178 Application. For example, the networked computer devices 102 can communicate instruction signals to the mobile electronic devices 104 used by operators to direct the mobile electronic devices 104 to generate displays for the operators that permit the operators to remotely obtain assistance with the monitoring, diagnosing, repair, replacement, and the like, of components of the assets. The mobile electronic devices 104 can receive visual, graphical, textual, or other information to remotely guide and instruct the operators through one or more workflows to repair or replace a component subsystem of assets in manner that warns the operators of unsafe practices and/or situations. The operators can use the mobile electronic devices 104 to notify the remotely located experts, other operators, networked computer devices 102, or the like, of one or more unsafe practices or situations involved with performance of the guidance being provided, as described in the '178 Application. For example, the operator can take a picture or video of the unsafe condition, optionally annotate the picture or video with hand drawn images, text, or the like, and send the picture or video (annotated or unannotated) to a remote location for review, such as by one or more expert personnel. Optionally, the operator can send a text based description of the unsafe condition, an audio recording that represents the sounds of the unsafe condition and/or the operator describing the unsafe condition, or other information indicative of the unsafe condition. The expert personnel or other person that receives the picture or video can then examine the unsafe condition and optionally revise the work scope or workflow, such as by removing or changing the tasks that result in the unsafe condition from the work scope or workflow. As another example from the '178 Application, a work scope or workflow presented on the mobile electronic device 104 can guide the operator through measuring dimensions of a wheel, determining if the dimensions need to be changed and/or if the wheel needs to be replaced, and/or locating a replacement wheel.

Another software application or functionality that may be provided by the mobile electronic device 104 can include various aspects and functions of the subject matter described in the '018 Application. For example, the mobile electronic device 104 can include a camera 304 that obtains image data of an asset. The image data can be obtained of a vehicle during a testing procedure and compared with a collection of exhaust images or data that may be digitally stored within a database, for example, in order to efficiently, accurately, and objectively determine the emissions generated by the vehicle and/or whether or not the vehicle passes an emissions test. The image of the vehicle may include an image of the vehicle and exhaust emitted from the vehicle, or only the exhaust emitted from the vehicle, for example.

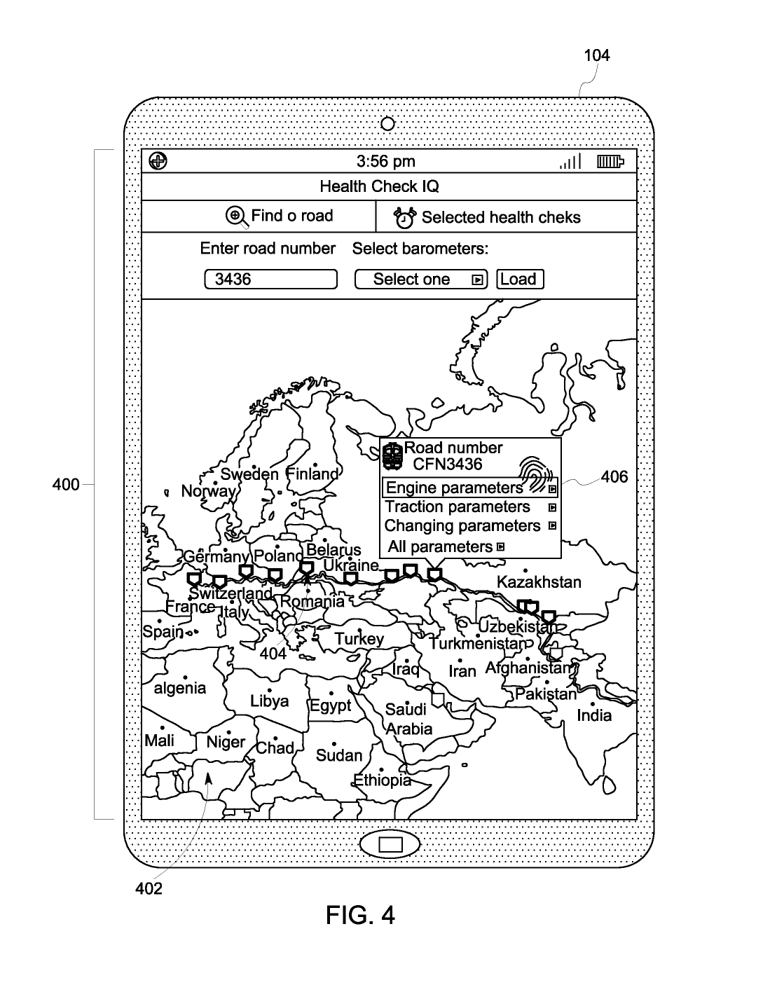

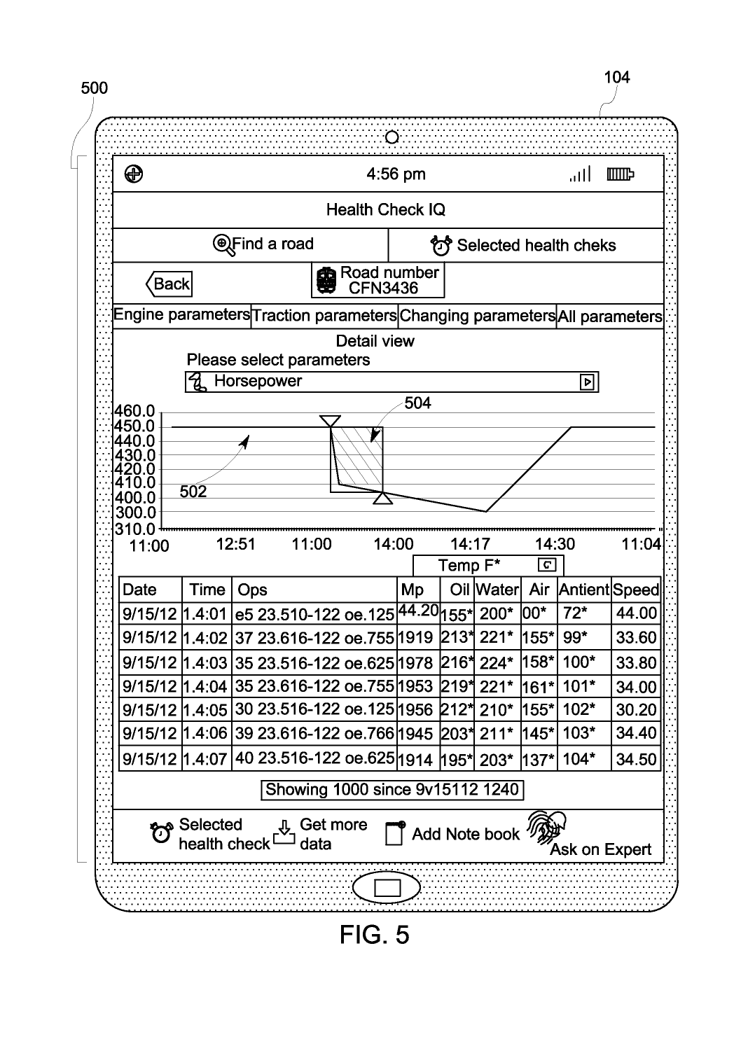

FIGS. 4 and 5 illustrate additional display screens 400, 500 that may be shown on the mobile electronic device 104 during a health check on one or more assets according to one example of the inventive subject matter described herein. The mobile electronic device 104 can remotely obtain data indicative of operations of assets that are located remote from the device 104. For example, the mobile electronic device 104 can transmit and/or broadcast a ping signal to an asset that is not near the device 104. This ping signal can request certain health data about the asset. The health data can be used by the mobile electronic device 104 to inform and/or assist the operator in remotely diagnosing and or troubleshooting problems with the asset.

For example, upon sending the ping signal to a remote asset, the asset can wirelessly communicate responsive health data to the networked computer devices 102 and/or to the mobile electronic device 104. This health data can include current operational data of asset, historical operational data of the asset, projected operational data of the asset, or the like. In the illustrated display screen 400 of FIG. 4, the mobile electronic device 104 displays a map 402 with several icons 404 representative of locations of various assets. The locations of the assets can be communicated from the mobile electronic devices 104 coupled with the assets to the networked computer devices 102. The mobile electronic device 104 that displays the map 402 can obtain these locations from the networked computer devices 102. Alternatively, the locations of the assets can be presented in another manner, such as a list, table, or the like, with geographic coordinates, textual indications of locations, distances from the mobile electronic device 104 that displays the map 402, or the like.

The operator can select one or more of the asset icons 404 shown on the map 400. When an asset icon 404 is selected, an additional display 406 of information about the asset at the corresponding location can be displayed on the mobile electronic device 104. In the illustrated example, the additional information includes engine parameters, traction parameters, charging parameters, and all parameters. The operator may select one or more of this additional information on the mobile electronic device 104 to obtain health data about the relevant components of the asset. For example, selecting engine parameters can cause the mobile electronic device 104 coupled with the asset to return data representative of engine operations of the asset, selecting traction parameters can cause the mobile electronic device 104 of the asset to return data representative of traction motors in the asset, selecting charging parameters can cause the mobile electronic device 104 of the asset to return data representative of electrical systems of the asset, and selecting all parameters can cause the mobile electronic device 104 of the asset to return a variety of other data, or all operational data that the mobile electronic device 104 of the asset has access to. Optionally, other types of data parameters may be listed on the mobile electronic device 104 for selection by the operator.

Responsive to selecting what information is requested by the operator on the mobile electronic device 104, the mobile electronic device 104 sends the ping signal to the asset. Responsive to receiving this ping signal, the mobile electronic device 104 connected to the asset and/or the networked computer devices 102 return the data parameters requested by the ping signal. The mobile electronic device 104 being used by the operator that requested the operational data of the asset can present the data to the operator. The display screen 500 shown in FIG. 5 provides one example of a presentation of the operational data.

The display screen 500 organizes the data that is returned from the asset responsive to receiving the ping signal. In the illustrated example, a graph 502 represents changes in the data over time, such as changes in horsepower output by the asset. The operator can examine the data on the mobile electronic device 104 to identify potential trouble issues or trouble spots. For example, a highlighted area 504 in the display screen 500 illustrates an abnormal drop in horsepower of the asset. The operator can examine the operational data representative of the horse power to identify and or determine one or more problems with the asset.

Other types of operational data can be returned to the mobile electronic device 104 of the operator and shown to the operator. For example, location data representative of current, past, and/or future locations of the asset. The operator of the mobile electronic device 104 can then use the location data to determine a work history of the assets, an upcoming work history of the assets, and/or locations both current, past, and/or future locations of the asset. Output data from the asset can be provided that represents one or more work outputs of the asset. With respect to vehicles, this data can include horse power output, generated electric current, or other output generated by the asset. Temperature data can be provided to represent water temperature, manifold air temperature, ambient temperature, oil temperature, or the like, of the asset. Other types of data also may be communicated to the mobile electronic device 104. The operator can obtain and review this operational data without being at or near the asset. Based on the identification of one or more problems with the asset from this data, the operator may use the mobile electronic device 104 to access one or more trouble shooting lists or other assistance guides to guide the operator through further inspection, repair, maintenance, or the like, of the asset, as described above.

As described in the '941 Application, the mobile electronic device 104 optionally may be used to determine if a sufficient workforce is available to complete designated tasks within a designated time period. For example, the mobile electronic device 104 and/or the networked computer devices 102 can calculate a labor shortfall for completion of a set of tasks within a designated time period. The labor shortfall can represent a difference between an amount of required workforce personnel, tools, equipment, and the like, that are needed to complete the set of tasks within the designated time period. The mobile electronic device 104 and/or the networked computer devices 102 may calculate an amount of available workforce personnel, tools, equipment, and the like, during the same designated time period. The available workforce personnel, tools, and/or equipment may be subject to constraints on how long the available workforce personnel can work within the designated time period and/or when the tools and equipment are available. The mobile electronic device 104 can present an indication of the labor shortfall and receive operator input in response thereto. The operator input can request additional personnel and/or a change in the order in which the tasks are completed to reduce the labor shortfall and/or to complete additional tasks within the designated time period.

The networked computer devices 102 and/or the mobile electronic device 104 can generate one or more communication signals that are sent to the mobile electronic devices of available workforce personnel. The communication signals request additional work from available workforce personnel in excess of the workforce constraints. Optionally, the networked computer devices 102 and/or the mobile electronic device 104 can change the order in which the tasks are to be completed, the location of tools and equipment used in completing the tasks, and/or movements of personnel in completing the tasks in order to reduce the labor shortfall. The new order of the tasks, locations of the tools, and/or movements can be communicated to mobile electronic devices 104 of the workforce personnel, who may then watch or otherwise view the new order, locations, and/or movements on the mobile electronic devices 104. The new order, tool/equipment locations, and/or movements of the operator may result in a scheduled set of tasks being completed in less time than a previous order, tool/equipment locations, and/or movements

The mobile electronic device 104 of an operator optionally may generate a status presentation that illustrates locations and/or the progress of completing a set of tasks on one or more assets. As described above, the mobile electronic devices 104 coupled with the assets can monitor and report operational data and/or locations of the assets to the networked computer devices 102. This information may then be conveyed to the mobile electronic device 104c of an operator and presented to the operator, such as in a map, graph, or other presentation.

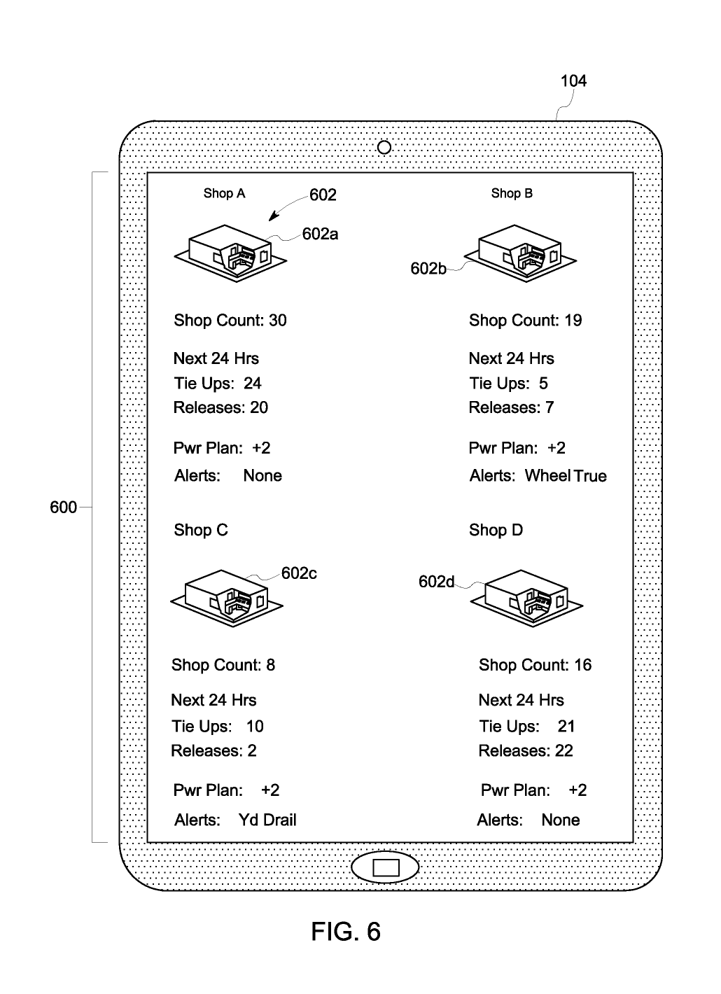

FIG. 6 illustrates another example of a status presentation 600 that can be visually presented on the mobile electronic device 104 of an operator according to one aspect of the inventive subject matter described herein. The status presentation may be shown to one or more of the operators to allow those operators to more easily check on the status of scheduled sets of tasks being performed on one or more assets at different locations.

The presentation 600 includes information about the status of tasks being performed on assets at different facilities 118 (shown in FIG. 1). These facilities may be located remote from each other and/or the mobile electronic device 104 that is displaying the presentation 600. In the illustrated example, four facility icons 602 (e.g., icons 602a-d) are shown with textual information shown below the icons 602. Each icon 602 and the text below the icon 602 represents the status of tasks being performed at a facility 118 represented by the icon 602.

Operational data and/or location information is communicated from the mobile electronic devices 104 connected to tools 106, equipment 108, assets, or the like, to the networked computer devices 102. The operational data can include sensor measurements, outputs, statuses of tasks (e.g., whether the tasks have been completed), or the like. The location information can indicate where the mobile electronic devices, tools, equipment, assets, or the like, are located. The networked computer devices 102 can send this data and/or information to the mobile electronic device 104c that displays the status presentation 600 periodically, on demand, or otherwise. Optionally, the operational data and/or location information may be sent from to the mobile electronic device 104c that displays the status presentation 600 without being sent to the networked computer devices 102 first.

The networked computer devices 102 and/or the mobile electronic device 104c can use the operational data and/or the location information to determine the statuses of completing a set of tasks on assets, predicted statuses of tasks during an upcoming time period, problems with the assets or tasks, or the like. In the illustrated example, the mobile electronic device 104c may examine the operational data and/or location information and determine that the “Shop A” facility 118 has thirty assets that are in the facility 118 (e.g., the “Shop Count” in FIG. 6). The operational data and/or location information also may indicate that twenty assets are scheduled to exit the facility 118 with in a designated time period of 24 hours due to the progress in completion of scheduled sets of tasks to be performed on the assets (e.g., the “Releases” in FIG. 6). Due to a lack of progress in the completion of some sets of tasks, labor shortfalls, and/or problems with tools, equipment, or the like (e.g., the tools and/or equipment needed to complete the tasks are unavailable or broken), the mobile electronic device 104c and/or networked computer devices 102 may determine that scheduled sets of tasks to be performed on twenty-four assets will not be completed within the designated time period (e.g., the “Tie Ups” in FIG. 6).

For example, different tasks may be associated with designated periods of time. These designated periods of time can be based on (e.g., calculated from) previous completions of the tasks, industry standards, or the like. If the time periods in which the tasks are actually completed are within (e.g., no greater than), the designated time periods, then the networked computer devices 102 and/or the mobile electronic device 104 can determine that the tasks are being completed on schedule. The networked computer devices 102 and/or mobile electronic device 104 can then determine that the set of tasks that is scheduled to be completed on one or more assets is expected to be completed on time. These assets may be included in the “Releases” shown in FIG. 6.

But, some tasks or sets of tasks may be in the process of being completed in time periods that are longer than the designated time periods of the tasks. As a result, the networked computer devices 102 and/or the mobile electronic device 104 can determine that the tasks are not being completed on schedule. The networked computer devices 102 and/or the mobile electronic device 104 can then determine that the set of tasks that is scheduled to be completed on one or more assets is not expected to be completed on time. These assets may be included in the “Tie Ups” shown in FIG. 6.

The mobile electronic device 104 optionally may inform the operator of an alarm state at one or more of the facilities 118. For example, if data sent from one or more assets, tools, and/or equipment indicates a fault or other problem with the asset, tool, and/or equipment, then the networked computer devices 102 and/or the mobile electronic device 104 may display an alarm to the operator (e.g., the “Alerts” shown in FIG. 6). The “Wheel True” alert can indicate that there is a problem encountered in the tasks of changing dimensions of a wheel and the “Yd Drail” can indicate that a rail vehicle has derailed. Optionally, other alerts can be generated.

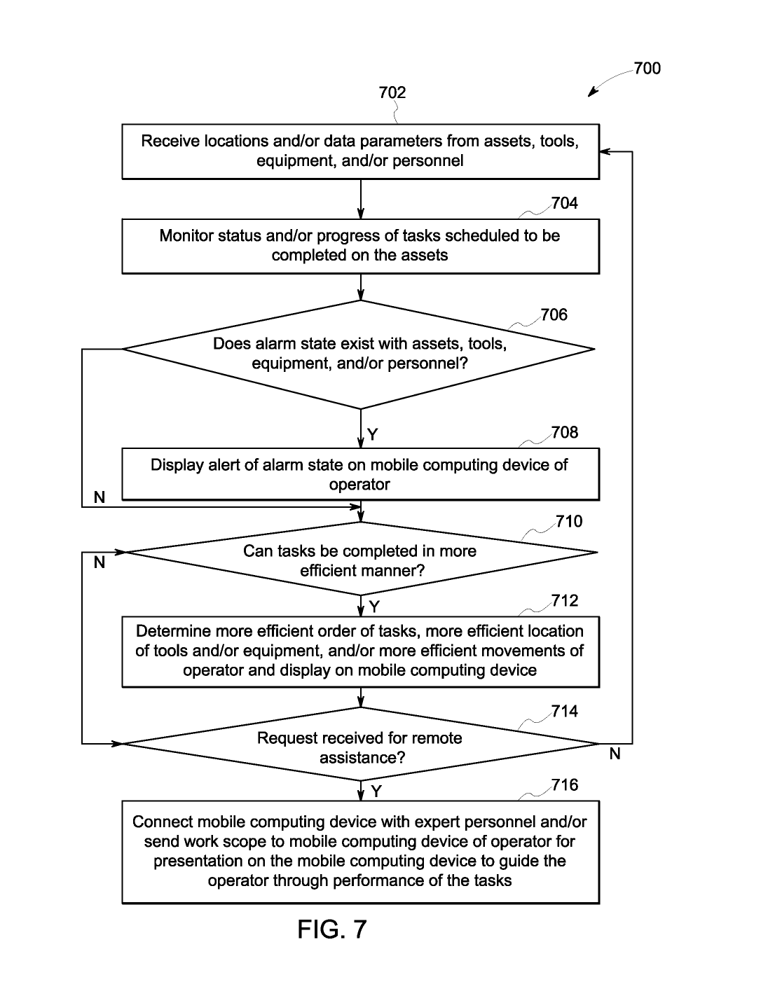

FIG. 7 illustrates a flowchart of a method 700 for assisting operators performing tasks on assets according to one example of the inventive subject matter described herein. The method 700 can be performed by the networked computer devices 102 and/or mobile electronic devices 104 shown in FIG. 1.

At 702, locations and/or data parameters are received from mobile electronic devices coupled or otherwise associated with assets, tools, equipment, and/or personnel. For example, the mobile electronic devices can report the locations of the mobile electronic devices, the status of completion of tasks on the assets by operators, tools, and/or equipment associated with the mobile electronic devices, data representative of operations, output, or the like of the tools, equipment, and/or assets.

At 704, the status and/or progress of a set of tasks to be performed on one or more of the assets are monitored. The status and/or progress can be monitored by examining the information received from the mobile electronic devices. For example, the actual times needed for completing the tasks can be compared to designated times and/or the rate at which tasks are being completed can be compared to a scheduled rate at which the tasks are to be completed. Optionally, the output of the assets can be compared to designated limits, ranges, or the like, to determine if there is a problem or fault with the assets, or if the assets are operating normally (e.g., within predefined limits). The states of the assets and/or progress of one or more sets of tasks scheduled to be completed on the assets can be presented on one or more of the mobile electronic devices.

At 706, a determination is made as to whether an alarm state exists with respect to one or more of the assets, tools, equipment, and/or personnel. For example, the operational data that are remotely monitored can be examined to determine if there is a problem or fault with a tool, equipment, and/or asset. As another example, the progress of completion of the tasks can be examined to determine if the tasks are being completed on schedule. If the operational data indicates a fault or problem, or the tasks are being completed behind schedule, then an alarm state may be identified. As a result, flow of the method 700 can proceed to 708. Otherwise, flow of the method 700 can continue to 710.

At 708, an alert that is indicative of the alarm state is presented on one or more mobile electronic devices. For example, the mobile electronic device carried by an operator may generate a warning to the operator so that the operator is aware of the alarm state, and which also may indicate the location of the alarm state, the asset that is the subject of the alarm state, or the like.

At 710, the information that is monitored from the mobile electronic devices is examined to determine if the tasks can be completed in a more efficient way. For example, the times at which the tasks are completed, the movements of the operator during completion of the tasks, the locations of the tools and equipment, or the like, can be examined. From this examination, a determination is made as to whether the tasks can be completed in less time and/or at a lesser cost if the order in which the tasks are completed is changed, the locations of tools and/or equipment are changed, and/or the movements of the operators in moving between the tasks and/or during performance of the tasks are modified. If the tasks can be completed in a more efficient manner (e.g., at a reduced completion time and/or reduced cost), then flow of the method 700 can proceed to 712. Otherwise, flow of the method 700 can proceed to 714.

At 712, the more efficient order of the tasks, more efficient location of tools and/or equipment, and/or more efficient movements of the operators are determined For example, the more efficient manner in which the tasks can be completed can be determined by the networked computer devices and communicated to the mobile electronic devices, as described in the '005 Application. The more efficient order of the tasks, locations of the tools and/or equipment, and/or more efficient movements of the operators can be displayed on the mobile electronic devices of the operators in order to guide the operators through performance of the tasks in the more efficient manner.

At 714, a determination is made as to whether an operator has requested remote assistance in performing one or more tasks on an asset. For example, the networked computer devices can determine if the mobile electronic device of an operator has communicated a request for guidance and/or assistance. The operators may request presentation of a work flow that visually guides the operators through completion of the tasks. Optionally, the operators may request to be connected with a remotely located person, such as a person having expertise or certification in a particular technology, so that the remotely located person can assist the operator. If such a request is received from the mobile electronic device of an operator, then flow of the method 700 can proceed to 716. Otherwise, flow of the method 700 can return to 702 so that continued locations and/or data of the assets, tools, equipment, and/or personnel can be monitored.

At 716, the mobile electronic device of the operator that submitted the request for assistance is connected with the computing device of an expert personnel and/or the mobile electronic device of the operator receives a work scope. As described herein, the expert personnel may remotely guide the operator through performance, inspection, or the like, of one or more tasks via the mobile electronic device. Optionally, the work scope can be obtained from a remotely located computing device and/or a database, and presented on the mobile electronic device in order to guide the operator through the tasks to be completed on an asset.

In one example of the inventive subject matter described herein, a method (e.g., for assisting operators performing tasks on assets) includes remotely monitoring locations of mobile electronic devices associated with performance of tasks on one or more assets by operators, remotely monitoring progress of completion of the tasks, and, based on at least one of the locations that are monitored or the progress of completion of the tasks, at least one of: altering an order in which the tasks are to be completed to reduce at least one of a completion time or completion cost of the tasks, communicatively coupling the mobile electronic devices with one or more expert personnel to assist the operators in completing the tasks, or generating a visual presentation on at least one of the mobile electronic devices that illustrates at least one of progress or problems with completion of the tasks.

In one aspect, the mobile electronic devices are coupled with at least one of equipment or one or more tools used to complete the tasks on the one or more assets, the locations of the mobile electronic devices communicated to one or more networked computer devices so that the one or more networked computer devices monitor the locations of the mobile electronic devices.

In one aspect, the method also includes receiving data parameters from the mobile electronic devices operatively coupled with the one or more assets. The data parameters can represent at least one of operational settings or output generated by the one or more assets. The method also can include directing at least one of the mobile electronic devices to visually present a status of the one or more assets that is remotely located from the at least one mobile electronic device. The status can be based on the data parameters.

In one aspect, the one or more assets include a vehicle and the tasks are performed on the vehicle in order to at least one of inspect the vehicle, repair the vehicle, or prepare the vehicle for departure from at least one of a facility or a vehicle yard.

In one aspect, the tasks are performed at plural different facilities, and wherein generating the visual presentation comprises directing at least one of the mobile electronic devices that is remotely located from the different facilities to display a summary of the progress of completion of the tasks at the different facilities.

In one aspect, the method also can include directing at least one of the mobile electronic devices to display the locations of the mobile electronic devices that are at or coupled with the one or more assets on at least one of the mobile electronic devices.

In one aspect, at least one of remotely monitoring the locations or remotely monitoring the progress of the completion of the tasks is performed by one or more networked computer devices disposed remote from the mobile electronic devices.

In another example of the inventive subject matter described herein, another method (e.g., for assisting operators performing tasks on assets) includes communicating instruction signals from one or more networked computer devices to one or more mobile electronic devices. The instruction signals direct the one or more mobile electronic devices to generate visual presentations to guide one or more operators through tasks to be completed on one or more assets. The method also can include receiving, from the one or more mobile electronic devices, responsive signals that notify the one or more networked computer devices of one or more of: locations of the one or more mobile electronic devices during performance of the tasks by the one or more operators, locations of at least one of tools or equipment used to perform the tasks, an indication of at least one of an unsafe condition or an unsafe task directed by the visual presentations, requests for remote assistance in completing the tasks by one or more expert personnel remotely located from the locations of the one or more mobile electronic devices, or progress of completion of the tasks. The method also can include, responsive to receiving the responsive signals, at least one of: altering an order in which the tasks are completed in order to at least one of eliminate the unsafe condition or unsafe task or reduce at least one of a completion time or completion cost of the tasks, communicatively coupling at least one of the operators with at least one of the expert personnel via the one or more mobile electronic devices, or visually presenting a summary of the progress of the completion of the tasks on at least one of the mobile electronic devices.

In one aspect, the mobile electronic devices are coupled with at least one of equipment or one or more tools used to complete the tasks on the one or more assets. The locations of the mobile electronic devices can be communicated to the one or more networked computer devices so that the one or more networked computer devices monitor the locations of the mobile electronic devices.

In one aspect, the method also can include receiving data parameters from the mobile electronic devices operatively coupled with the one or more assets. The data parameters can represent at least one of operational settings or output generated by the one or more assets. The method may further comprise directing at least one of the mobile electronic devices to visually present a status of the one or more assets that is remotely located from the at least one mobile electronic device. The status can be based on the data parameters.

In one aspect, the one or more assets include a vehicle and the tasks are performed on the vehicle in order to at least one of inspect the vehicle, repair the vehicle, or prepare the vehicle for departure from at least one of a facility or a vehicle yard.

In one aspect, the tasks are performed at plural different facilities, and wherein visually presenting the summary comprises directing at least one of the mobile electronic devices that is remotely located from the different facilities to display a summary of the progress of completion of the tasks at the different facilities.

In one aspect, the method also includes directing at least one of the mobile electronic devices to display the locations of the mobile electronic devices that are at or coupled with the one or more assets on at least one of the mobile electronic devices.

In one aspect, the method also includes at least one of remotely monitoring the locations or remotely monitoring the progress of the completion of the tasks by one or more networked computer devices disposed remote from the mobile electronic devices.

In one aspect, the method also includes directing at least one of the mobile electronic devices to present locations of the expert personnel to allow the one or more operators to select the location of at least one of the expert personnel in order for the one or more operators to be communicatively coupled with the at least one of the expert personnel via the one or more mobile electronic devices.

In another example of the inventive subject matter described herein, a system (e.g., an operator assistance system) includes one or more networked computer devices including one or more computer processors. The one or more networked computer devices are configured to remotely monitor locations of mobile electronic devices associated with performance of tasks on one or more assets by operators. The one or more networked computer devices also are configured to receive signals from the mobile electronic devices and, based on the signals that are received, remotely monitor progress of completion of the tasks on the one or more assets and, based on at least one of the locations that are monitored or the progress of completion of the tasks, at least one of: alter an order in which the tasks are to be completed to reduce at least one of a completion time or completion cost of the tasks, communicatively couple the mobile electronic devices with one or more expert personnel to assist the operators in completing the tasks, or generate a visual presentation on at least one of the mobile electronic devices that illustrates at least one of progress or problems with completion of the tasks.

In one aspect, the mobile electronic devices are coupled with at least one of equipment or one or more tools used to complete the tasks on the one or more assets, and the one or more networked computer devices are configured to receive the locations of the mobile electronic devices so that the one or more networked computer devices monitor the locations of the mobile electronic devices.

In one aspect, the networked computer devices also are configured to receive data parameters from the mobile electronic devices operatively coupled with the one or more assets. The data parameters can represent at least one of operational settings or output generated by the one or more assets. The networked computer devices also can be configured to direct at least one of the mobile electronic devices to visually present a status of the one or more assets that is remotely located from the at least one mobile electronic device. The status can be based on the data parameters.

In one aspect, the one or more assets include a vehicle and the tasks are performed on the vehicle in order to at least one of inspect the vehicle, repair the vehicle, or prepare the vehicle for departure from at least one of a facility or a vehicle yard.

In one aspect, the tasks are performed at plural different facilities, and the one or more networked computer devices also are configured to generate the visual presentation by directing at least one of the mobile electronic devices that is remotely located from the different facilities to display a summary of the progress of completion of the tasks at the different facilities.

In one aspect, the one or more networked computer devices are configured to direct at least one of the mobile electronic devices to display the locations of the mobile electronic devices that are at or coupled with the one or more assets on at least one of the mobile electronic devices.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

What is claimed is:

1. A method comprising:
remotely monitoring locations of mobile electronic devices associated with performance of tasks on one or more assets by operators;
remotely monitoring progress of completion of the tasks; and
based on at least one of the locations that are monitored or the progress of completion of the tasks, at least one of:
altering an order in which the tasks are to be completed to reduce at least one of a completion time or completion cost of the tasks,
communicatively coupling the mobile electronic devices with one or more expert personnel to assist the operators in completing the tasks, or
generating a visual presentation on at least one of the mobile electronic devices that illustrates at least one of progress or problems with completion of the tasks.

2. The method of claim 1, wherein the mobile electronic devices are coupled with at least one of equipment or one or more tools used to complete the tasks on the one or more assets, the locations of the mobile electronic devices communicated to one or more networked computer devices so that the one or more networked computer devices monitor the locations of the mobile electronic devices.

3. The method of claim 1, further comprising:
receiving data parameters from the mobile electronic devices operatively coupled with the one or more assets, the data parameters representing at least one of operational settings or output generated by the one or more assets; and
directing at least one of the mobile electronic devices to visually present a status of the one or more assets that is remotely located from the at least one mobile electronic device, the status based on the data parameters.

4. The method of claim 1, wherein the one or more assets include a vehicle and the tasks are performed on the vehicle in order to at least one of inspect the vehicle, repair the vehicle, or prepare the vehicle for departure from at least one of a facility or a vehicle yard.

5. The method of claim 1, wherein the tasks are performed at plural different facilities, and wherein generating the visual presentation comprises directing at least one of the mobile electronic devices that is remotely located from the different facilities to display a summary of the progress of completion of the tasks at the different facilities.

6. The method of claim 1, further comprising directing at least one of the mobile electronic devices to display the locations of the mobile electronic devices that are at or coupled with the one or more assets on at least one of the mobile electronic devices.

7. The method of claim 1, wherein at least one of remotely monitoring the locations or remotely monitoring the progress of the completion of the tasks is performed by one or more networked computer devices disposed remote from the mobile electronic devices.

8. A method comprising:
communicating instruction signals from one or more networked computer devices to one or more mobile electronic devices, the instruction signals directing the one or more mobile electronic devices to generate visual presentations to guide one or more operators through tasks to be completed on one or more assets;
receiving, from the one or more mobile electronic devices, responsive signals that notify the one or more networked computer devices of one or more of:
locations of the one or more mobile electronic devices during performance of the tasks by the one or more operators,
locations of at least one of tools or equipment used to perform the tasks,
an indication of at least one of an unsafe condition or an unsafe task directed by the visual presentations,
requests for remote assistance in completing the tasks by one or more expert personnel remotely located from the locations of the one or more mobile electronic devices, or
progress of completion of the tasks; and
responsive to receiving the responsive signals, at least one of:
altering an order in which the tasks are completed in order to at least one of eliminate the unsafe condition or unsafe task or reduce at least one of a completion time or completion cost of the tasks,
communicatively coupling at least one of the operators with at least one of the expert personnel via the one or more mobile electronic devices, or
visually presenting a summary of the progress of the completion of the tasks on at least one of the mobile electronic devices.

9. The method of claim 8, wherein the mobile electronic devices are coupled with at least one of equipment or one or more tools used to complete the tasks on the one or more assets, the locations of the mobile electronic devices communicated to the one or more networked computer devices so that the one or more networked computer devices monitor the locations of the mobile electronic devices.

10. The method of claim 8, further comprising:
receiving data parameters from the mobile electronic devices operatively coupled with the one or more assets, the data parameters representing at least one of operational settings or output generated by the one or more assets; and
directing at least one of the mobile electronic devices to visually present a status of the one or more assets that is remotely located from the at least one mobile electronic device, the status based on the data parameters.

11. The method of claim 8, wherein the one or more assets include a vehicle and the tasks are performed on the vehicle in order to at least one of inspect the vehicle, repair the vehicle, or prepare the vehicle for departure from at least one of a facility or a vehicle yard.

12. The method of claim 8, wherein the tasks are performed at plural different facilities, and wherein visually presenting the summary comprises directing at least one of the mobile electronic devices that is remotely located from the different facilities to display a summary of the progress of completion of the tasks at the different facilities.

13. The method of claim 8, further comprising directing at least one of the mobile electronic devices to display the locations of the mobile electronic devices that are at or coupled with the one or more assets on at least one of the mobile electronic devices.

14. The method of claim 8, further comprising directing at least one of the mobile electronic devices to present locations of the expert personnel to allow the one or more operators to select the location of at least one of the expert personnel in order for the one or more operators to be communicatively coupled with the at least one of the expert personnel via the one or more mobile electronic devices.

15. A system comprising:
one or more networked computer devices including one or more computer processors, the one or more networked computer devices configured to remotely monitor locations of mobile electronic devices associated with performance of tasks on one or more assets by operators, wherein the one or more networked computer devices also are configured to receive signals from the mobile electronic devices and, based on the signals that are received, remotely monitor progress of completion of the tasks on the one or more assets and, based on at least one of the locations that are monitored or the progress of completion of the tasks, at least one of:
alter an order in which the tasks are to be completed to reduce at least one of a completion time or completion cost of the tasks,
communicatively couple the mobile electronic devices with one or more expert personnel to assist the operators in completing the tasks, or
generate a visual presentation on at least one of the mobile electronic devices that illustrates at least one of progress or problems with completion of the tasks.

16. The system of claim 15, wherein the mobile electronic devices are coupled with at least one of equipment or one or more tools used to complete the tasks on the one or more assets, and the one or more networked computer devices are configured to receive the locations of the mobile electronic devices so that the one or more networked computer devices monitor the locations of the mobile electronic devices.

17. The system of claim 15, wherein the networked computer devices also are configured to receive data parameters from the mobile electronic devices operatively coupled with the one or more assets, the data parameters representing at least one of operational settings or output generated by the one or more assets, and to direct at least one of the mobile electronic devices to visually present a status of the one or more assets that is remotely located from the at least one mobile electronic device, the status based on the data parameters.

18. The system of claim 15, wherein the one or more assets include a vehicle and the tasks are performed on the vehicle in order to at least one of inspect the vehicle, repair the vehicle, or prepare the vehicle for departure from at least one of a facility or a vehicle yard.

19. The system of claim 15, wherein the tasks are performed at plural different facilities, and the one or more networked computer devices also are configured to generate the visual presentation by directing at least one of the mobile electronic devices that is remotely located from the different facilities to display a summary of the progress of completion of the tasks at the different facilities.

20. The system of claim 15, wherein the one or more networked computer devices are configured to direct at least one of the mobile electronic devices to display the locations of the mobile electronic devices that are at or coupled with the one or more assets on at least one of the mobile electronic devices.
